(19) United States
(12) Patent Application Publication
(10) Pub. No.: US 2026/0350894 A1
(43) Pub. Date: Nov. 5, 2026

(54) SYNCHRONOUS PATTERNED MOTION AVATARS

(71) Applicant: THE COURT OF EDINBURGH NAPIER UNIVERSITY, CONSTITUTED BY THE NAPIER COLLEGE OF COMMERCE & TECHNO, Edinburgh (GB)

(72) Inventors: Kenny MITCHELL, Edinburgh (GB); David SINCLAIR, Edinburgh (GB); Charalampos KONIARIS, Edinburgh (GB); Adeyemi ADEMOLA, Edinburgh (GB)

(73) Assignee: THE COURT OF EDINBURGH NAPIER UNIVERSITY, CONSTITUTED BY THE NAPIER COLLEGE OF COMMERCE & TECHNO, (omitted)

(21) Appl. No.: 19/487,282

(22) PCT Filed: May 24, 2024
(86) PCT No.: PCT/EP2024/064444

§ 371 Date: Nov. 24, 2025

(30) Foreign Application Priority Data
May 26, 2023 (GB) 2307952.8

(51) Int. Cl. G06T 13/20; G06T 13/40; H04L 1/00

(52) U.S. Cl. CPC G06T 13/205; G06T 13/40; H04L 1/0018

(57) ABSTRACT

A method, a computer program product and a computing device displays two or more synchronised avatars on a local device, each avatar performing patterned motion based on a human movement. First data signals are received and represent a first patterned motion data signal indicative of a movement pattern of a first human of the local device and second data signals are received, wherein the second data signals represent a second patterned motion data signal indicative of a movement pattern of a second human of a remote device, the local and remote devices being connected. A predicted patterned motion of the second human is based on second data signals, a modified patterned motion of the second human subject is based on predicted patterned motion of the second human. The local device displays a first avatar based on the first data signals synchronously with a second avatar based on the modified patterned motion of the second human on a display of the local device.

### FIELD

The present disclosure relates to synchronous patterned motion avatars.

### BACKGROUND

In recent years, the use of avatars has increased and utilised for many purposes from gaming, virtual meetings and other virtual gatherings, between human subjects at different locations. The avatars are used to represent the human subjects in a characteristic or a realistic form. In situations, such as virtual meetings, latency between distributing the human movement patterns between remotely located computing devices of the human subjects to be represented and displayed on each computing device as avatars then latency is not an issue. However, in other situations, such as two dance partners performing a synchronised dance routine, e.g. a waltz, a salsa, and so on, the issue of latency causes a lag between the movement patterns of the two dance partners which is undesirable and renders synchronised patterned motion avatars, e.g. representing synchronised movement patterns between remote human subjects, difficult to implement as the avatar representing the remote human subject will lag behind the avatar representing the local human subject.

Conventional avatar systems simply cannot provide synchronised patterned motion avatars for at least two dance partners, e.g. for practice or training purposes, where the two dance partners synchronously perform the dance routine remotely due to the latency issues.

The present disclosure therefore seeks to address, at least in part, the problems and drawbacks mentioned above and to provide a means for synchronous patterned motion avatars.

### SUMMARY

According to a first aspect of the present invention there is provided a method of displaying two or more synchronised avatars on a local computing device, each avatar performing at least patterned motion based on a movement pattern of a human subject, the method comprising: receiving one or more first data signals, wherein the one or more first data signals represent a first patterned motion data signal indicative of a movement pattern of a first human subject of the local computing device; receiving one or more second data signals, wherein the one or more second data signals represent a second patterned motion data signal indicative of a movement pattern of a second human subject of a remote computing device, the local computing device and the remote computing device being connected via a communication network; determining a predicted patterned motion of the second human subject based at least on the one or more second data signals; determining a modified patterned motion of the second human subject based on the predicted patterned motion of the second human subject; and displaying, on the local computing device, a first avatar based on the received one or more first data signals synchronously with a second avatar based on the determined modified patterned motion of the second human subject.

In some embodiments, determining the predicted patterned motion of the second human subject may be further based on the one or more first data signals.

In some embodiments, the method may further comprise: tracking the patterned motion of the second human subject based on one or more previous second data signals; and wherein determining the predicted patterned motion of the second human subject is further based on the tracking.

In some embodiments, determining the predicted patterned motion of the second human subject may be further based on one or more of a synchronised motion pattern comprising one or more set movement patterns, and data indicative of a human natural movement pattern limits.

In some embodiments, the method may further comprise identifying audio data, wherein the audio data may correspond to audio accompanying the movement pattern of the human subjects.

In some embodiments, determining the predicted patterned motion of the second human subject may be further based on the analysed audio data; preferably wherein the audio data is analysed to determine one or more rhythmic motion features.

In some embodiments, determining the predicted patterned motion of the second human subject may further comprise: performing a frequency analysis of a time series of joint motions relating to the movement pattern of a second human subject of a remote computing device; and identifying a beat of the audio signal.

In some embodiments, determining a modified patterned motion of the second human subject may further comprise: modifying patterned motion of the second human subject based on the analysed time series of joint motions synchronously with the identified beat of the audio signal.

In some embodiments, determining a modified patterned motion of the second human subject may further comprise: determining a cadence of the predicted patterned motion; and modifying the patterned motion of the second human subject based on the determined cadence.

In some embodiments, the one or more first data signals may be received by the local computing device from one or more first input components operatively connected to the local computing device; and the one or more second data signals may be received by the local computing device from the remote computing device via the communication network, wherein the one or more second data signals may originate from one or more second input components operatively connected to the remote computing device.

In some embodiments, the method may further comprise: applying a trained optimisation scheme to determining the predicted synchronous patterned motion of the human subjects; wherein the optimisation scheme is trained on an informed metric evaluation.

In some embodiments, the method may further comprise: reducing latency in the local computing device and/or the communications network.

In some embodiments, reducing latency may further comprise: intercepting the one or more first data signals received from the input components operatively connected to the local computing device and/or the one or more second data signals received from the communications network at the local computing device; and distributing the one or more first data signals and/or the one or more second data signals to a corresponding consumer, by bypassing latency inducing components and processes of the local computing device.

In some embodiments, the intercepted one or more first data signals may be distributed to the communication network consumer for transmission to the remote computing device synchronously with the distribution to one or more other respective consumers of the local computing device.

In some embodiments, the step of distributing may further comprise: storing the one or more first data signals and/or the one or more second data signals in a memory of the local computing device; and sharing access to the one or more first data signals and/or the one or more second data signals in the memory of the local computing device to the corresponding consumer of the respective data signal.

According to a second aspect of the present invention there is provided a computer program product comprising computer readable executable code for implementing a method according to one or more of the features of the first aspect.

According to a third aspect of the present invention there is provided a computing device comprising; a processor; and a memory; wherein the memory stores computer readable executable code that, when executed by the processor, cause the computing device to implement a method according to one or more of the features of the first aspect.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

### DRAWINGS

FIG. 1 shows a simplified schematic diagram of an arrangement according to one or more embodiments of the present invention.

FIG. 2 shows a simplified schematic diagram of a computing device according to one or more embodiments of the present invention.

FIGS. 3a and 3b show a simplified schematic diagram illustrating a prediction and modification process according to one or more embodiments of the present invention.

### MAIN DESCRIPTION

The present disclosure seeks to address the challenge of achieving synchronized online dancing, or any other synchronised motion between two or more human subjects, against the latency inherent in the transmission of network signals among remote dance partners and the latency inherent in conventional computing devices (e.g. in a 3D avatar rendering engine, processing data signals from input/output devices connected to the computing devices, transmitting data signals via a network to remote computing devices, and so on).

In one or more embodiments, an application on the computing devices can predict and modify the patterned motion of an avatar representing the movement pattern of the remote human subject based on one or more of a number of data types, including, for example, the current and/or previously received movement pattern of the remote human subject at a remote computing device, and the audio signal at a local computing device of the local human subject. The audio signal may be the music to which the dance routine the two remote dance partners are synchronously performing and being played on the computing devices. By predicting the patterned motion of the avatar representing the remote human subject, any latency in the transmission and processing of data signals from the remote computing device can be compensated for, thereby effectively reducing the latency to substantially to Oms.

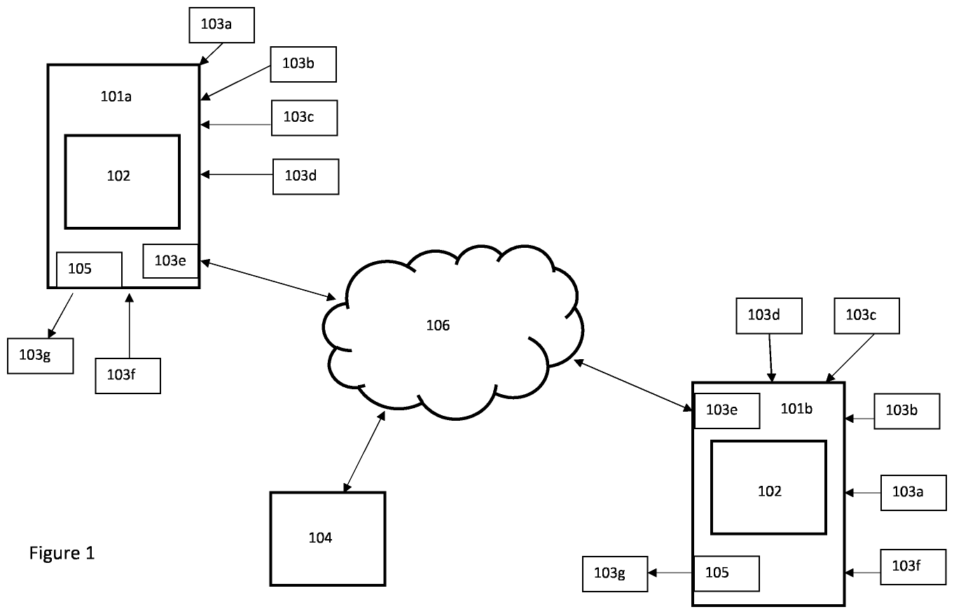

One or more embodiments will now be described in detail with reference to FIG. 1. Each computing device 101 (i.e. remote 101a and local 101b) includes a motion prediction module 102. Each computing device is connected to one or more I/O components 103, for example, camera 103a, Inertial Measurement Unit (IMU) sensors 103b, microphone 103c, speakers 103d, network interface 103e, haptic sensors 103f, display 103g, and so on. As will be appreciated, there may be any number of I/O components 103 of any type that may be utilised in the present invention.

The computing devices 101 are connected via at least one communications network 106, for example, one or more of a local area network, a wide area network, the world wide web, and so on, such that the computing devices can communicate over the at least one communications network. The computing devices may additionally communicate via a server 104 as an intermediatory between the computing devices.

The local computing device 101b may receive remote data signals relating to a movement pattern of the human subject at the remote computing device 101a via the network interface 103e of the local computing device 101b. The local computing device 101b further receives local data signals relating to a movement pattern of the human subject at the local computing device 101b via the camera 103a and/or motion sensors 103b.

The local computing device 101b includes a graphics engine 105 which renders on a display 106 of the local computing device 101b an avatar representation for each of the remote human subject and the local human subject. The avatar may be a 3D representation of the human subjects that is based on a mesh and/or skeletal framework. The graphics engine 105 may be any suitable graphics engine, such as an off-the-shelf games engine, which performs the operations of rendering 3D graphics and playing audio to the appropriate output devices, as well as optionally calculating collision detection in the 3D space.

The graphics engine 105 can render the patterned motion of the avatar of the local human subject on the local computing device display based on the local data signals relating to the movement pattern of the local human subject. The local data signals relating to the movement pattern of the local human subject can be obtained from one or more of a camera, wearable motion sensors, 3D scanner, and so on. As mentioned hereinabove, the graphics engine can be a conventional graphics engine and as such, a skilled person in the art would readily understand how to generate and render a patterned motion 3D avatar based on a detected human subject's movement pattern and therefore a detailed explanation of the operation of the conventional graphics engine is not reproduced herein.

At the remote computing device, the movement pattern of the remote human subject is obtained as remote data signals from one or more capable devices (e.g. a camera, wearable IMUs, 3D scanner, and so on). The remote computing device transmits the respective remote data signals to the local computing device via the communications network. The local computing device receives the remote data signals via the local network interface. There will be an inherent and inevitable latency between the detection of the remote human subject's movement pattern and the local computing device receiving the remote data signals corresponding to those movement patterns of the remote human subject over the communication network. If the remote data signals where rendered on an avatar by the graphics engine on receiving those remote data signals then the latency would mean the patterned motion of the avatar representing the remote human subject would be out of sync with the accompanying audio (e.g. musical composition) and/or the patterned motion of the avatar representing the local human subject. This is of particular importance when the local and remote human subjects are performing a synchronised and/or collaborative dance routine, or other synchronised or collaborative motion, which may include a particular piece of music.

The motion prediction module operates, or is configured, to predict and modify the patterned motion of the avatar representation of the remote human subject movement pattern such that it appears the avatar of the remote human subject is not being affected by the latency inherent in the arrangement (e.g. the communications network, the polling, buffering and rendering within the local computing device, etc.), when displayed on the local computing device display. That is the avatar of the remote human subject appears to be synchronised with the local human subject irrespective of the latency inherent in the communication network and the local computing device.

The motion prediction module may take into account one or more data types wherein the more data types included in the motion prediction the greater the accuracy and realism of the predicted motion pattern of the avatar representing the remote human subject on the local computing device display. The data types may include data relating to the local human subject movement pattern as, in a synchronised or collaborative dance, knowing the position of the local human subject movement pattern may provide an indication of the next movement pattern of the remote human subject.

The prediction may be based on a data type relating to one or more current data, wherein the current data may be indicative of the remote human subject movement pattern (e.g. current data signals from various sensors such as a camera, IMUs and so on), indicative of the local human subject movement pattern (e.g. current data signals from various sensors such as a camera, IMUs and so on), and/or data signals from haptic devices, wherein the haptic devices provide data signals relating to a collision (e.g. a touch or a hold) between the avatars of the remote and local human subjects.

The prediction may additionally or alternatively be based on a data type relating to one or more previous data signals, wherein the previous data signals may include one or more of the previous patterned motion of the avatar representing the remote human subject, one or more of the previous patterned motion of the avatar representing the local human subject, one or more of the previous data signals indicative of a previous remote human subject movement pattern, and/or one or more of the previous data signals indicative of a previous local human subject movement pattern. The use of previous data enables the motion prediction module to track the patterned motion of the avatar thereby providing a more realistic predicted patterned motion of the avatar at a given point in time. The history context of the received signals may be used to inform an ideal current perceived synchronous pose for each remote partner for best experience of each partner. Thus the motion prediction module may be assisted to predict, given the history of previous pose frames, a trajectory giving confidence in continuing that trajectory if otherwise not conflicting with other information such as collisions or dance beat expected motion inflections.

The prediction may additionally or alternatively be based on a data type relating to one or more other data, wherein the other data may be indicative of the synchronised motion pattern, e.g. the particular dance which has set movement patterns, a human natural movement pattern limits, e.g. the maximum hip sway, or any other movement pattern of a human subject.

The prediction may additionally or alternatively be based on a data type relating to audio data, wherein the audio data relates to the audio, e.g. music, accompanying the synchronised motion. By taking into account the audio data rhythmic movement patterns may be identified which improves the accuracy of the predicted patterned motion of the avatar at a given point in time.

The motion prediction module may further predict and modify the patterned motion of the avatar based on the accompanying audio data being played by a speaker device at both the local computing device and the remote computing device. In this case the motion prediction module may predict and modify the patterned motion of the avatar according to the rhythmic motion features of the dance's local music time context so that the remote dancers avatars appear locally to have synchronous ‘in-time’ motions with the musical beat. The motion prediction module can remap these detected rhythmic motion features in time according to, e.g. synchronously with, the beat of the musical sequence. Frequency analysis of the audio data, e.g., the music, may determine primary and tertiary rhythms.

Since the motion prediction module can drive motion temporal corrections on the sparse avatar rig skeletal motion into the MoSh IK framework, the resulting motions are physically plausible accordingly. The MoSh IK framework enables the prediction to work efficiently on a few joints, wherein only a few joints are enough to recover the whole detailed volume mesh of the person dancing.

The motion temporal corrections may relate to, for example, facial expression, skin movement, style of joint movement, and so on. For example, a foot stomp in a flamenco dance has quite a different impact expression if ‘remapped’ with aggression vs simply re-timed for synchronisation. In a dance, timed patterned motions can be detected or signal important features of the dance. The rhythmic motion features may be distinguishing elements of dance that may define and detect according to classes of descriptors, e.g. clicking castanets in flamenco, tap dance heel-step, ball change, etc. Both the music beat and skeleton joint motion can be inferred, for example, in respect of a known dance with an accordingly known dance music rhythm. Both sets of sensed skeleton joint motion and the inferred music rhythm combine to inform the synchronous dance ideal pose between remote dancers, in the general case to result in least friction and smooth dance flow, without degrading spontaneity.

The motion prediction module may additionally or alternatively predict and modify the incoming, or previously received, remote data signals relating to the remote human subject movement pattern to determine a cadence, such as an amplification or exaggeration, of the patterned motion of the avatar, e.g. exaggerate a particular movement pattern such as a hip sway to improve or enhance the ability of the remote human subject. Thus, the motion prediction module may amplify or exaggerate the periodic patterned motions to yield exaggerated and emphasized dance motions of avatars with controlled parameterisation of body motion zones such as hips, shoulders, hands, etc.

The motion prediction module may perform a frequency analysis of each of a hierarchy of skeleton joint motion cycles for each patterned step of the dance. That is, the trajectories of skeleton joints form periodical curves in space over time and these provide coefficients at various orders comprising the natural human motion.

The frequency analysis may include identifying a periodogram to determine the dominant periods (or frequencies) of a time-series of skeleton joint motions of the dance to identify the dominant cyclical skeleton joint motions, e.g. the extremities of hip-sway motions. For example, the periodogram may identify the dominant frequencies in the time series of skeleton joint motions by decomposing into cosine/sine waves of various amplitudes, phase and periods. Animation of avatars in real-time rendering is often performed by applying the pose of the avatar at a given frequency of playback. In order to form any pose for any frame, samples recorded of the pose's joint skeleton hierarchy over time may be obtained as the ‘time-series’. Sample poses for each joint at each frame may be obtained from one or more data signals from one or more sensors, e.g. a camera or IMU sensors, wherein the respective data signals may be received at the capture rate of the sensor such that the graphics engine may interpret those pose samples to render the current frame of the avatar, based on the prediction. The prediction may be based on an interpolation.

Thus, the motion prediction module may predict the motion pattern of the avatar representing the remote human subject based on one or more of the data types and or analysis described hereinabove.

The motion prediction module may then modify (e.g. remap) the avatar of the remote human subject based on the predicted motion. Given a motion pose frame composed of a hierarchy of skeleton joints, the motion prediction module may modify one or more coefficients (e.g. rotation and offset) of each skeleton joint to conform to the predicted target synchronous remote human subject pose, e.g. movement pattern. The modification may be an intelligent optimized computation based on the data types, for example, as many data types available may be used in the prediction in order to minimize the error of the current sensed pose of the local human subject and the received delayed remote human subject(s) pose(s) to result in a synchronous perception of in time dance flow. This may be performed by evaluating an error metric on the composition of the data types used for the prediction as an objective function of, for example, pose, music beat, collisions, etc., and minimizing the objective function by adapting those variables through gradient descent approach or prior trained optimisation scheme such as a deep learned adaption.

Further, one or more optimisation schemes, such as deep learning approaches, may be applied, for example, to sparse rig-to-mesh motion models. The optimisation scheme, e.g. deep learning, may be trained using a fully informed metric evaluation, for example, a large dataset of partner dance motions which may provide ground truth actual correct dance pair (or more) poses from which to match the context of the sensed/received live online dance context, in order to provide a strong estimate of the best expected dance pose. The skeleton joint pose hierarchy of partners in addition to the audio context at the given playhead/timestamp, may be used as inputs to an MLP which trained on the large dataset with a loss function on the ideal dance pose, provides that pose as an output.

A further optimisation scheme, e.g. deep learning approach, relates to body pose mesh volume reconstruction from sparse joint inputs. This scheme may use MoSh parameterized body model approach which is a tuned data driven reconstruction method using SMPL learned body pose skinning model in a regression framework, or to use alternative optimisation schemes, such as neural network approaches, with less analytic directness, e.g. SMPLR. In either case, the optimisation scheme is used to predict synchronous patterned motion efficiently with sparse joints and then infer the body volume mesh detail from just those sparse joints. One more optimisation schemes may also be used in the context of motion prediction of sparse joints such that the prediction can be applied for the purpose of online motion synchronization in real-time with awareness of latency and pattern motion context. The optimisation schemens may be trained on a fully informed metric evaluation relevant to the given optimisation scheme.

By predicting and modifying the remote data signals representing the patterned motion of the respective avatar, the effects of latency due to the inherent delays introduced by transmitting the signals over the communication network to the local computing device can substantially be compensated for.

However, due to the latency that is introduced by the conventional architecture any error between the predicted and modified movement pattern of the remote human subject and subsequent actual movement patterns of the remote human subject may be more pronounced in the avatar display rendered at the local computing device of the local human subject.

Therefore, it may be beneficial to also reduce the latency in the arrangement so that any error between the predicted and modified movement pattern of the remote human subject and subsequent actual movement patterns of the remote human subject can be minimised. Thus, enabling a more effective and synchronous perception of the two remote human subjects dancing together. Furthermore, by reducing the latency in the arrangement it contributes to lower durations of required motion prediction for assured synchronisation of the avatars according to the accompanying music.

Accordingly, in one or more embodiments, there is provided one or more unique approaches to reducing the latency inherent in the arrangement to further enhance the prediction and modification.

The approaches seek to significantly reduce latency across the architecture, including, but not limited to, the transmission of data signals between remote computing devices, receiving and processing data signals originating from and being provided to input/output (I/O) devices, and the 3D avatar modelling graphics engine. The approaches aim to implement a “direct as possible” low latency synchronisation of networked patterned motions represented as avatars, e.g. enables dancing online together where the partners are remotely located away from each other but connected online via a communications network, such as the internet. The unique principle of direct as possible processing effectively bypasses unnecessary, slow or bloated processing components of each step between the hardware device sensing a remote partners' motion to mapping, translating, transforming and styling that motion, and relay to the other partners at other locations with focused short-cutting for the lowest latency outcome. In other words, the direct as possible processing reduces latency by effectively bypasses the latency inducing components and processes of the local computing device.

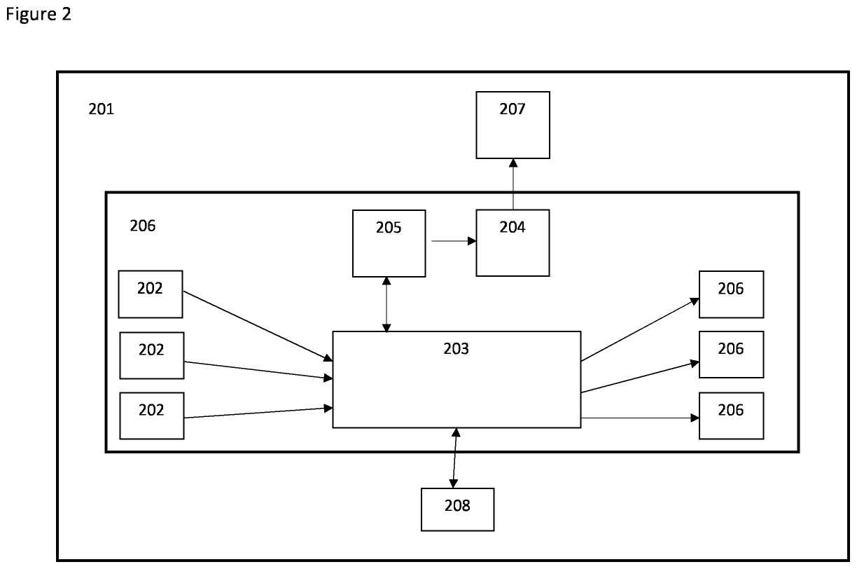

The latency reduction approaches that may be used in combination with the prediction and modification approach will now be described in detail with reference to FIGS. 1 and 2.

Referring to FIG. 1, two or more computing devices 101 at different locations are connected by a communication network 106. The communication network 106 may include one or more networks, such as a local area network, a wide area network, the World Wide Web, and so on. The two or more computing devices 101 may communicate directly over the communication network 106 or may communicate via one or more servers 104. Each of the computing devices are operatively connected to one or more I/O devices 103, e.g. cameras, 3D scanners, motion sensors, wearable motion sensors, haptic devices, a display (e.g. a virtual reality headset, a monitor/screen), a network interface, and so on.

FIG. 2 shows a simplified schematic of one of the computing devices 201. The computing device 201 includes a primary application 206, wherein the primary application may include one or more computer implemented modules that operate, or are configured to, significantly reduce the latency of various aspects of the communication to and from devices and entities.

As shown in FIG. 2, the primary application 206 of the computing device 201 includes one or more Producer Modules (PM) 202, a Signal Manager Module (SMM) 203, one or more Consumer Modules (CM) 206, and a Graphics Engine Plugin Module (GEPM) 205. The modules may be written in any suitable computer programming language, for example, C++ which enables a portable and low latency, high-performance approach to communications between sensors, applications, and other clients across the network.

The graphics engine plugin module 205 may be configured to operate as an interface to a graphics engine 204, wherein the graphics engine 204 may be any suitable off the shelf graphics engine for rendering 3D avatars on the display 207 of the computing device 201, for example a games engine.

The one or more PMs 302 intercept incoming data signals from “producers” of the data signals, for example, producers may include one or more of the camera, motion sensors, UMUs, haptic devices, the network interface receiver, and so on. As will be appreciated, there may be any number of producers depending on the input devices and components connected to the computing device. Thus, the PMs 202 may be considered to be hardware drivers for the input devices and/or a network listener, which can intercept data signals originating from the producer. The PMs may intercept incoming data signals from producers by, for example, accessing native device Application Program Interface (API) of the producer, e.g., a camera. By intercepting the data signals the embodiments effectively bypass a layer of plugin framework that graphic engines typically build above the native device layer.

Thus, an enabler of lower latency in embodiments of the present invention is this intercept of data signals before they arrive in the local computing device software update loop. In other words, the reduction in latency can be achieved and enabled by effectively bypasses the standard architecture and processes of the local computing device.

For example, a PM 202 for intercepting data signals from a camera operatively connected to the computing device to track a human subject's movement pattern, can intercept the data signal from the camera, e.g. bypassing the normal transition of the data signal to the graphics engine, and either extract tracking information from the data signal if the camera provides the tracking information, or the PM 202 can calculate the tracked motion based on raw camera data received. The tracking information may be, or indicative of, a collection of points of the human subject's body that result from image processing, either in 2d, 3d or directly to skeleton joint poses.

As will be appreciated, a PM 202 may be provided for each input device, e.g. the producer which may be any device connected to the computing device that produces a data signal or provides any other data type, and the respective PM 202 may extract the relevant data information from the data signal or determine the necessary data information based on the data signal intercepted.

The SMM 203 receives an intercepted data signal from the PMs 202 and routes the respective data signal to the appropriate CM 206. The SMM may be a static configuration according to each computing devices hardware setup, where only a few computing devices are connected via the communication network. If a large number of computing devices are connected via the communication network the SMM may further perform load balancing according to proximity of the local computing device. The SMM 203 may maintain a record or log to track which producer data signals are linked to which consumers. The SMM may implement the record by managing a configuration state of the links, regularly defined statically, but not required static, and flexible or dynamic to content conditions or hardware/network changes.

In order to reduce the latency in the distribution of data signals to the consumers, the SMM 203 may share access to memory 208 in which the data signals are stored by the SMM 203. This may be advantageous as it minimises copying of the data signals which incur memory copying operations, thereby reducing the latency in providing the data signals to the consumers from the producers. In one example, the SMM 203 may distribute pointers between the producers and the consumers to a memory location at which the respective data signals are stored in the memory. Therefore, the pointers may point to in-memory data structures allocated by the SMM 203. Furthermore, the SMM 203 may also optionally associate metadata, wherein the metadata may provide or indicate schema information of the data contained in memory, device buffers, format info, and so on.

The CMs 206 may be provided for each consumer of the data signals from the producer. The consumers may include, for example, a network interface transmitter, the GEPM, saving the data to a file, actuators, haptic vests, and so on. The CMs 206 may be implemented to be agnostic to the type of signal data being consumed. Thus, the embodiments provide a flexible modular specifications of event-driven processing with input sensor and output actuator producers and consumers processing live streams of multimodal data, selectively published and subscribed to according to the access of each computing devices available devices and compute power.

As the data signals from the local producers to the local computing device 201 are intercepted by the PMs 202 and passed to the SMM 203 for distribution to the consumers via CMs 206, then data signals from the producers can be automatically and simultaneously transmitted to the remote computing devices via the network interface transmitter consumer as well as to the local consumers in the local computing device. Therefore, in embodiments an enabler of lower latency is this intercept of signals before they arrive in the local computing traditional software update loops, primarily those of the graphics engine, before being transmitted to the communications network to the remote computing device. Data signals from local sensor hardware (e.g. producers) are sent to the local consumers at the same time as they are sent to the communication network so that local computing device software related sources of latency are significantly reduced.

A further cause of latency relates to the traditional graphics engine 204, e.g. a games engine. In the traditional graphics engine 204 latency is introduced by polling the data and performing networking logic at the rate of the graphics engine's update step. Ensuring synchronization between a local data signal and a remote avatar representation involves multiple steps. However, these steps add to the overall latency, which can be further compounded by the structure of the graphics engine 204 and the buffering of data. Accordingly, in traditional graphics engines the data signal, in order to be synchronized with the remote avatar representation, would need to be polled in the local computing device, then sent to the networking subsystem, which will then send the data to the remote computing device (most likely at a future update step due to buffering or execution order), which will be transmitted over the network to the remote computing device, which will read that data during its own update step and inform the remote computing device graphics engine to render the avatar at that or a future update step. Thus, a number of update steps are executed and each step adds to the total latency.

This latency can be significantly reduced by the GEPM 205. The GEPM 205 may be a plugin for the graphics engine 204 which receives the data signal or a pointer in a shared memory inter-process communication, or other data transfer mechanism thereby effectively bypassing many of the steps that introduce latency. The GEPM 205 may then convert the data signals for use with the graphics engine's 204 standard data-processing facilities without having to be processed by the graphics engine 204 and the numerous update and buffering steps that would traditionally and conventionally be required.

As an example, a traditional graphics engine may acquire a data signal relating to the output of a camera in, for example, approximately 79.3 ms at which time it is queued to be transmitted by the communications network to the remote computing device. In contrast, by intercepting the data signals from the camera by the respective PM then the data information from the camera can be directly sent to the network interface transmitter in approximately 16.5 ms on average, resulting in a latency saving of approximately 62.8 ms, which is achieved by effectively bypassing the update loop of the graphics engine in relation to making the data signal available to the network interface transmitter to the remote computing devices.

A further latency reduction may be achieved by implementing a bespoke network buffering infrastructure. One or more embodiments of the present invention are able to route the network infrastructure from the local computing device to a server and to the remote computing devices in just under 10 ms, on average, saving an expected 3.01 ms in network buffering. For example, with a native socket implementation the network message type and direction to the SMM is handled natively thereby reducing latency. In contrast, with a high level networking implementation the routing of messages may be generically processed involving additional buffering and processing lists of generically registered handlers. Furthermore, this latency reduction is in addition to that described above.

As well as offering significant latency savings by effectively bypassing the traditional graphics engine networking infrastructure, the direct as possible approach of the embodiments may further provide significant savings when measured isolated from networking and viewing only locally generated signals. Here, the data signal from the camera is sent to the graphics engine 204 on the local computing device 201 for outputting on a display 207. A traditional graphics engine may take approximately 79.3 ms to make the camera data signal available to the graphic engine's scripting facilities. In contrast, by intercepting the data signals by the respective PM 202 from the camera then the data signal reached the graphics engine's scripting facilities, via the GEPM 205, in approximately 24.8 ms, on average, providing a latency saving of approximately 54.5 ms, which is independent of networking and only subject to the graphics engine update loop architecture delays.

In the context of real-time online synchronous patterned motion, such as a partner or group dance, little time is afforded to compression of motion signals, as this would increase the latency in the system. However, it has been identified that the required bandwidth can be reduced based on a focus on low-cost quantization of quaternion pose joint orientations. By reducing the required bandwidth used by quantization advantageously results in faster stream delivery, e.g. the delivery of data signals to/from connected computing devices. Furthermore, by effectively providing a faster stream delivery, it advantageously reduces the duration of predictions required meaning that the synchronised patterned motion of the avatars is more realistic and would lead to fewer errors in the prediction. Each joint of a sparse human avatar rig was analysed independently across a range of dance motions to efficiently define per joint and quaternion component's numerical ranges, in order to determine compression with minimal loss of data. For example, for a corpus of dance motions, each joints' motion was iterated throughout each dance and the numerical ranges of motions of those joints were determined.

Furthermore, because of the redundancy in the quaternion representation, one of the quaternion components could be discarded and reconstructed from the other three, for example, the ‘w’ component of an (x, y, z, w) quaternion was almost always the largest, and therefore the best candidate to be dropped, negating the need to use two bits per quaternion to indicate the dropped component. This approach is essentially lossless and reduced overall motion data signal transmissions to two-thirds of the original network data stream size. The approach is lossless in the sense that the definition is sufficient to fully recover the original quaternion among the dance motion dataset analysed. By implementing the bandwidth reduction based on the quaternion component then a substantial number of, e.g. at least 30, simultaneous online dance motion signals is achievable.

In addition to the bandwidth reduction described above, a perceptually unnoticeable oriented lossy compression scheme could be implemented to yield further bandwidth reductions.

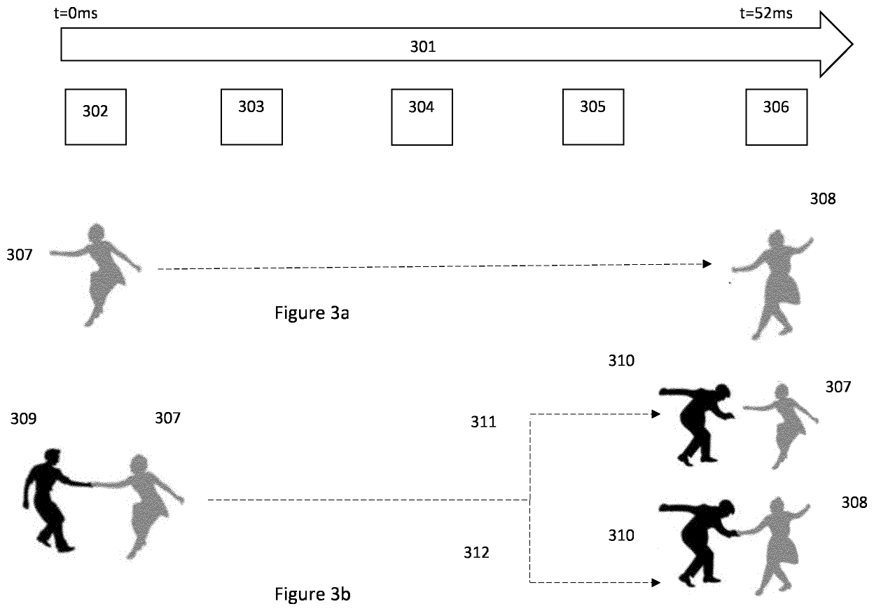

FIGS. 3a and 3b show a schematic diagram of the prediction and modification process including the latency reduction schemes described hereinabove according to one or more embodiments of the present application. Arrow 301 shows increasing time from t=0 ms on the left to t=52 ms on the right which is applicable to both FIG. 3a and FIG. 3b. As will be appreciated, the time in milliseconds provided in the example of FIGS. 3a and 3b may be dependent on the hardware of the computing devices and the communications network. Referring to FIG. 3a, at t=0 ms the remote human subject 307 is, at that instant in time, in one pose of a dance and the remote human subject 307 is captured by a camera whilst performing a movement pattern 302. At a time of approximately t=20 ms the remote computing device, using the primary application of the present invention which reduces latency, generates the remote human subjects body tracking pose data based on the camera data signal 303. At a time of approximately t=21 ms the remote human subjects body tracking pose data is processed by the primary application of the remote computing device and transmitted via the communication network to the local computing device of a local human subject 304. At approximately t=51 ms the remote human subjects body tracking pose data is received as a data signal by the primary application at the local computing device 305. At approximately t=52 ms the primary application at the local computing device processes the received data signal relating to the remote human subjects body tracking pose data 306. In the meantime, whilst the data signals are transmitted from the remote computing device to the local computing device the remote human subject continues to dance, i.e. changed their movement pattern, such that at t=52 ms the remote human subject is in a slightly different pose 308.

FIG. 3b shows the advantageous effects of the embodiments of the present invention. At time t=0, the avatars of the local human subject 309 and the remote human subject 307 are synchronised which may be based on previously predicted pattern motion of the avatar representing the remote human subject. At approximately t=52 ms the local human subject has continued to dance, i.e. changed their movement pattern, which is reflected in the avatar representing the local human subject 310 as the data signals relating to the movement pattern of the local human subject are processed locally by the primary application and the respective avatar output to the display. As shown by arrow 311, if pattern motion prediction and modification is not performed then at approximately t=52 ms the avatar of the remote human subject 307 and the local human subject 310 as shown on the display of the local computing device is not synchronised. This is because even with the latency reduction of the embodiments of the present invention there will be an inherent latency in the architecture meaning that the avatar representing the remote human subject will be that of t=0 ms 307 and not the current patterned motion 308 of the remote human subject. Thus, the avatar representing the remote human subject will not be synchronised with the avatar of the local human subject. However, as shown by arrow 312, with the prediction and modification of the pattern motion of the avatar representing the remote human subject of the embodiments of the present invention, the avatar representing the remote human subject 308 on the display of the local computing device at approximately t=52 ms is synchronised with the avatar representing the local human subject 310 as the prediction compensates for the inherent latency delay. As discussed hereinabove, the prediction may use one or more of the previously received data signals relating to the movement pattern of the remote human subject to track the pattern motion of the avatar representing the remote human subject, rhythm information in the audio data accompanying the synchronised dance and prior knowledge of the dance step, i.e. movement pattern, being performed, which is used to modify the motion pattern of the avatar of the remote human subject on the display of the local computing device.

In the above described embodiments, the two remotely located human users may be performing synchronised movement patterns that includes perceived contact between the remote human subjects, such as a particular hold in a dance routine. In this case, the human subjects may wear haptic devices, such as a haptics vest, in which the primary application includes a CM for the haptic devices enabling the remote human subjects to realistically feel the “contact” in a synchronous manner. The GEPM or the CM may determine a collision between the remote human subjects, or receive a data signal relating to a collision, and cause the haptic devices to actuate and respond based on the detected or determined collision.

In the above described embodiments, the present invention is described in relation to synchronous patterned motion avatars for two remote dance partners performing a synchronised dance. However, as will be appreciated the embodiments of the present invention are equally applicable to synchronised patterned motion avatars for any number of human subjects, for example, performing a group synchronised dance such as a line dance, a Caleigh, and so on. Furthermore, it will be appreciated that the embodiments of the present invention are equally applicable to any other synchronised movement and interaction of remotely located human subjects.

In the foregoing embodiments, features described in relation to one embodiment may be combined, in any manner, with features of a different embodiment in order to provide a more efficient and effective synchronous patterned motion avatars. Note that, the above description is for illustration only and other embodiments and variations may be envisaged without departing from the scope of the invention as defined by the appended claims.

1. A method of displaying two or more synchronised avatars on a local computing device, each avatar performing at least patterned motion based on a movement pattern of a human subject, the method comprising:
receiving one or more first data signals, wherein the one or more first data signals represent a first patterned motion data signal indicative of a movement pattern of a first human subject of the local computing device;
receiving one or more second data signals, wherein the one or more second data signals represent a second patterned motion data signal indicative of a movement pattern of a second human subject of a remote computing device, the local computing device and the remote computing device being connected via a communication network;
determining a predicted patterned motion of the second human subject based at least on the one or more second data signals;
determining a modified patterned motion of the second human subject based on the predicted patterned motion of the second human subject; and
displaying, on the local computing device, a first avatar based on the received one or more first data signals synchronously with a second avatar based on the determined modified patterned motion of the second human subject.

2. The method of claim 1, in which determining the predicted patterned motion of the second human subject is further based on the one or more first data signals.

3. The method of claim 1, further comprising:
tracking the patterned motion of the second human subject based on one or more previous second data signals; and
wherein determining the predicted patterned motion of the second human subject is further based on the tracking.

4. The method of claim 1, in which determining the predicted patterned motion of the second human subject is further based on one or more of a synchronised motion pattern comprising one or more set movement patterns, and data indicative of a human natural movement pattern limits.

5. The method of claim 1, further comprising:
identifying audio data, wherein the audio data corresponds to audio accompanying the movement pattern of the human subjects.

6. The method of claim 5, in which determining the predicted patterned motion of the second human subject is further based on the analysed audio data; preferably wherein the audio data is analysed to determine one or more rhythmic motion features.

7. The method of claim 5, in which determining the predicted patterned motion of the second human subject further comprises:
performing a frequency analysis of a time series of joint motions relating to the movement pattern of a second human subject of a remote computing device; and
identifying a beat of the audio signal.

8. The method of claim 7, in which determining a modified patterned motion of the second human subject further comprises:
modifying patterned motion of the second human subject based on the analysed time series of joint motions synchronously with the identified beat of the audio signal.

9. The method of claim 1, in which determining a modified patterned motion of the second human subject further comprises:
determining a cadence of the predicted patterned motion; and
modifying the patterned motion of the second human subject based on the determined cadence.

10. The method of claim 1, in which the one or more first data signals are received by the local computing device from one or more first input components operatively connected to the local computing device; and the one or more second data signals are received by the local computing device from the remote computing device via the communication network, wherein the one or more second data signals originate from one or more second input components operatively connected to the remote computing device.

11. The method of claim 1, further comprising:
applying a trained optimisation scheme to determining the predicted synchronous patterned motion of the human subjects; wherein the optimisation scheme is trained on an informed metric evaluation.

12. The method of claim 1, further comprising:
reducing latency in the local computing device and/or the communications network.

13. The method of claim 12, in which reducing latency further comprises:
intercepting the one or more first data signals received from the input components operatively connected to the local computing device and/or the one or more second data signals received from the communications network at the local computing device; and
distributing the one or more first data signals and/or the one or more second data signals to a corresponding consumer, by bypassing latency inducing components and processes of the local computing device.

14. The method of claim 12, in which the intercepted one or more first data signals are distributed to the communication network consumer for transmission to the remote computing device synchronously with the distribution to one or more other respective consumers of the local computing device.

15. The method of claim 13, in which the step of distributing further comprises:
storing the one or more first data signals and/or the one or more second data signals in a memory of the local computing device; and
sharing access to the one or more first data signals and/or the one or more second data signals in the memory of the local computing device to the corresponding consumer of the respective data signal.

16. A computer program product comprising computer readable executable code for implementing a method comprising:
receiving one or more first data signals, wherein the one or more first data signals represent a first patterned motion data signal indicative of a movement pattern of a first human subject of the local computing device;
receiving one or more second data signals, wherein the one or more second data signals represent a second patterned motion data signal indicative of a movement pattern of a second human subject of a remote computing device, the local computing device and the remote computing device being connected via a communication network;
determining a predicted patterned motion of the second human subject based at least on the one or more second data signals;
determining a modified patterned motion of the second human subject based on the predicted patterned motion of the second human subject; and
displaying, on the local computing device, a first avatar based on the received one or more first data signals synchronously with a second avatar based on the determined modified patterned motion of the second human subject.

17. A computing device comprising;
a processor; and
a memory;
wherein the memory stores computer readable executable code that, when executed by the processor, cause the computing device to implement a method comprising:
receiving one or more first data signals, wherein the one or more first data signals represent a first patterned motion data signal indicative of a movement pattern of a first human subject of the local computing device;
receiving one or more second data signals, wherein the one or more second data signals represent a second patterned motion data signal indicative of a movement pattern of a second human subject of a remote computing device, the local computing device and the remote computing device being connected via a communication network;
determining a predicted patterned motion of the second human subject based at least on the one or more second data signals;
determining a modified patterned motion of the second human subject based on the predicted patterned motion of the second human subject; and
displaying, on the local computing device, a first avatar based on the received one or more first data signals synchronously with a second avatar based on the determined modified patterned motion of the second human subject.
